(19) United States
(12) Patent Application Publication
(10) Pub. No.: US 2004/0215788 A1
(43) Pub. Date: Oct. 28, 2004

(54) System and method for associating a device with an existing service account

(76) Inventor: Robert P. Morris, Raleigh, NC (US)

Correspondence Address: SAWYER LAW GROUP LLP, P O BOX 51418, PALO ALTO, CA, 94303, US

(21) Appl. No.: 10/845,693

(22) Filed: May 13, 2004

Related U.S. Application Data
(63) Continuation-in-part of application No. 10/658,999, filed on Sep. 9, 2003.
Application No. 10/658,999 is a continuation of application No. 09/625,824, filed on Jul. 26, 2000, now Pat. No. 6,636,259.

(51) Int. Cl. G06F 15/16

(52) U.S. Cl. 709/227

(57) ABSTRACT

A method and system for associating a portable electronic device with an existing service account with minimal user input on the device connects the device to a gateway server. If the device is not associated with a gateway account or a temporary account, then the gateway server creates a temporary account for the device. When the gateway server receives an association of the device to an existing account with a service site, it converts the temporary account to a gateway account associated with the device and the existing account, and transfers any data for the temporary account to the existing account. In this manner, a portable electronic device can use certain services without first requiring the user to associate the device to an existing account. The user need not enter addressing or authentication information on the device to access this service, but can enter it from an input friendly device.

### CROSS-REFERENCE TO RELATED APPLICATIONS

The present application is a continuation-in-part of co-pending U.S. patent application Ser. No. 10/658,999, entitled “Automatically Configuring a Web-Enabled Digital Camera to Access the Internet,” filed on Sep. 9, 2003, which is a continuation of U.S. Pat. No. 6,636,259.

### FIELD OF THE INVENTION

The present invention relates to a method and system for customizing electronic devices, and more particularly to automatically configuring a web-enabled electronic device to access the Internet.

### BACKGROUND OF THE INVENTION

The popularity of using portable electronic devices, such as personal digital assistants (PDA), cellular phones, or digital cameras, to access specific web services via the Internet is increasing. For example, a user may capture a digital image with a digital camera imbedded in a cellular phone and may wish to share that image by uploading it to a photo-sharing site. To do so, the user typically has to have an account with the service site, enter address information to locate the service, and once located, provide authentication information such as a username and password.

However, entering data on portable electronic devices is not an easy task given the small displays and buttons on these devices. In addition, when the user purchases or obtains a new portable electronic device, the user must re-enter the addressing, authentication, or configuration data on the device before the device can be used with that service account.

Accordingly, what is needed is a method and system for associating a portable electronic device with an existing web service account with minimal user input on the device. The present invention addresses such a need.

### SUMMARY OF THE INVENTION

A method and system for associating a portable electronic device with an existing service account with minimal user input on the device have been disclosed. The method and system connects a portable electronic device to a gateway server. If the device is not associated with a gateway account or a temporary account, then the gateway server creates a temporary account for the device. When the gateway server receives an association of the device to the existing account with the service site, it converts the temporary account to a gateway account associated with the device and the existing account, and transfers any data for the temporary account to the existing account. In this manner, a portable electronic device can use certain services without first requiring the user to associate the device to an existing account with the service. The user need not enter addressing or authentication information on the device to access this service. Also, the user can enter addressing or authentication information from a more input friendly device, such as a personal computer, rather than into the device to associate it with the user's existing account with the service.

### BRIEF DESCRIPTION OF THE DRAWINGS

FIG. 1 illustrates an embodiment of a system for associating a portable electronic device with an existing service account with minimal user input on the device in accordance with the present invention.

FIG. 2 is a flowchart illustrating an embodiment of a method for associating a portable electronic device with an existing service account with minimal user input on the device in accordance with the present invention.

FIG. 3 is a flowchart illustrating in more detail the method for associating a portable electronic device with an existing service account with minimal user input on the device in accordance with the present invention.

FIG. 4 is a flowchart illustrating an extension to the embodiments of a method for associating a portable electronic device with an existing service account with minimal user input on the device in accordance with the present invention.

FIG. 5 is a flowchart illustrating the second embodiment of a method for associating a portable electronic device with an existing service account with minimal user input on the device in accordance with the present invention.

### DETAILED DESCRIPTION OF THE INVENTION

The present invention relates to a method and system for associating a portable electronic device with an existing service account with minimal user input on the device. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

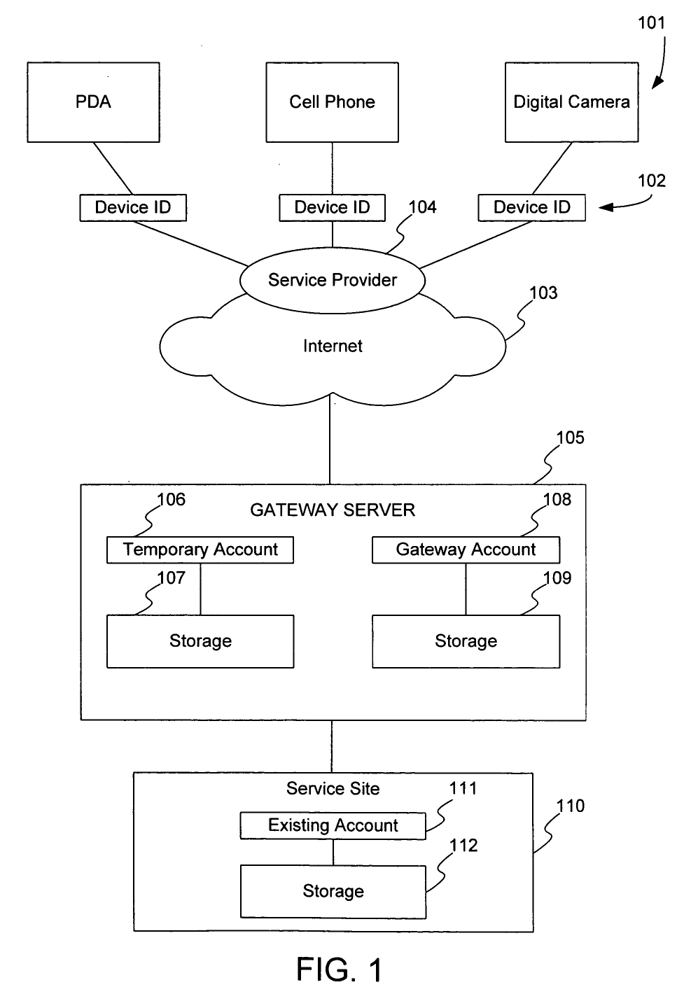

FIG. 1 illustrates an embodiment of a system for associating a portable electronic device with an existing service account with minimal user input on the device in accordance with the present invention. The system includes any one of a plurality of portable electronic devices 101, such as a personal digital assistant (PDA), cellular phone, or digital camera. Each device 101 has a unique device identifier (device ID) 102. The device ID 102 can be assigned to the device 101 by the device manufacturer or can be assigned at a later time; for example, by a reseller or service provider. The system further includes one or more on-line service sites 110 accessible through a gateway server 105, via the Internet 103 and an Internet service provider (ISP) 104. The service site 110 maintains existing accounts 111 and storage 112 associated with the existing accounts. “Existing account”, as used in this specification, refers to an account with a service site where access to the service is allowed.

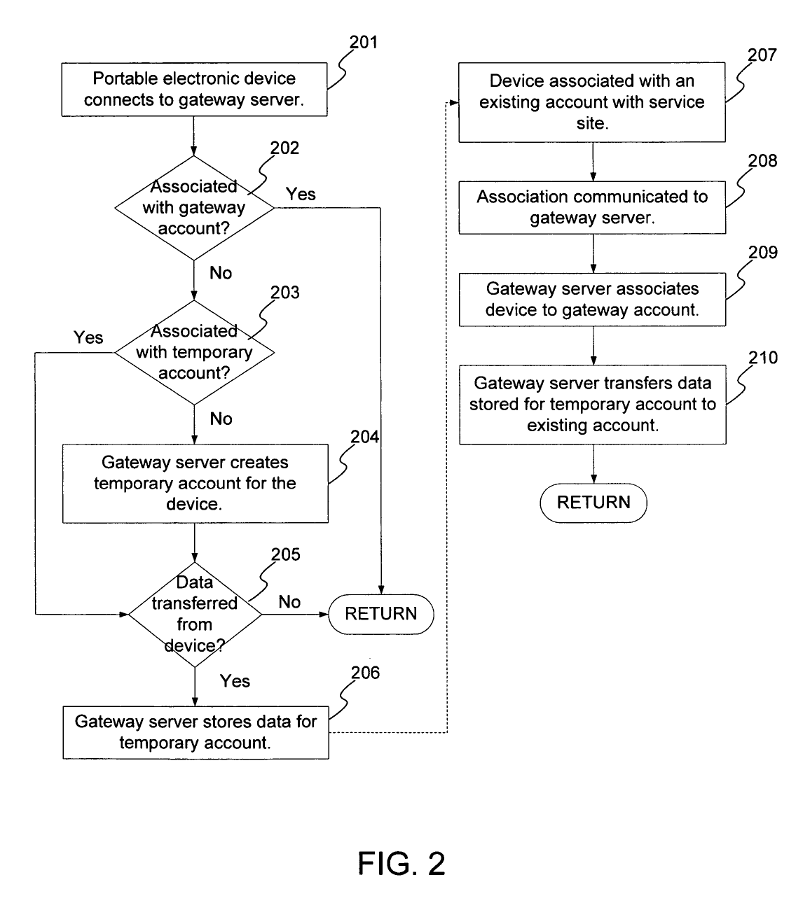

At the gateway server 105, temporary accounts 106 and storage 107 associated with the temporary accounts 106 can be created and maintained for a portable electronic device 101. The gateway server 105 can also create and maintain gateway accounts 108 and storage 109 for the gateway accounts 108. “Temporary account”, as used in this specification, refers to an account usable by a portable electronic device for a service where identifying information is lacking to bind the account to an existing account 111. “Gateway account”, as used in this specification, refers to an account which contains data that binds or associates a device with an existing account 111. For example, when some information needed for full access is yet to be obtained, such as user ID and password, a temporary account is used by the device 101. When enough information exists to bind a temporary account 106 to an existing account 111, the temporary account is either converted to a gateway account by adding the binding information or merged into an existing gateway account also by adding the binding information. The use of the temporary 106, gateway 108, and existing 111 accounts are further described below with reference to FIG. 2. Note that the gateway server 105 and the service sites 110 can be run on separate servers or can be run on the same server. If run on the same server, the gateway account 108 and existing account 111 may be implemented as one entity rather than two.

FIG. 2 is a flowchart illustrating an embodiment of a method for associating a portable electronic device with an existing service account with minimal user input on the device in accordance with the present invention. First, the portable electronic device 101 connects to the gateway server 105, via step 201. Here, the portable electronic device 101 is “internet-enabled”, where the device 101 is capable of direct connectivity to the Internet 103. For example, this connection can be accomplished as described in co-pending U.S. patent application Ser. No. 10/658,999, entitled “Automatically Configuring a Web-Enabled Digital Camera to Access the Internet,” filed on Sep. 9, 2003 and incorporated herein by reference. The portable electronic device 101 can be provided with a default ISP 104 information during manufacturing or by a reseller or distributor, including an ISP access number, and user ID and password (if required). After connecting with the ISP 104, the device 101 connects to the gateway server 105.

The gateway server 105 then determines if the device 101 is associated with a gateway account 108, via step 202. If not, then the gateway server 105 determines if the device 101 is associated with a temporary account, via step 203. If not, then the gateway server 105 creates a temporary account 106 for the device 101, via step 204. Once the temporary account 106 has been created, the device 101 can be used and data from the device 101 can be transferred to the gateway server 105, via step 205. For example, if the device 101 is a cellular phone camera, the user of the device 101 can proceed with taking pictures and transferring them to the gateway server 105 for an on-line photo service site 110 or some other service site. Once the gateway server 105 receives data transferred from the device 101, it stores the data in the storage 107 for the temporary account 106, via step 206.

At some time later, the user associates the device 101 with an existing account 111 with the service site 110, via step 207. For example, the user of the device 101 can log into an existing account 111 with a service site 110 from a personal computer, add the device 101 to the list of owned devices, and associate the device 101 to the service. This association is then communicated to the gateway server 105, via step 208. Alternatively, the user can first create a new account with the service site 110, and then associate the device 101 to this newly created existing account 111. In a further alternative, the user can visit the gateway server 105 site, and provide the identifying device 101 and existing account 111 information directly to the gateway server 105.

Once the association of the device 101 with an existing account 111 by the user has been communicated to the gateway server 105, the gateway server 105 associates the device 101 to the existing account 111, via step 209, and transfers the data stored for the temporary account 106 associated with the device 101 to a storage 112 for the existing account 111, via step 210. If the gateway server is unable to transfer the data from storage 107 to storage 112, it places the data in storage 109 associated with the gateway account 108 which servers as a cache for data to be transferred later. The association is accomplished by adding the existing account information to either the temporary account 106, thus creating a new gateway account 108 for the user, or the user's gateway account 108 if it already exists.

In this manner, a portable electronic device 101 can use certain services without first requiring the user to associate the device 101 to an existing account 111 with the service. The user need not enter addressing or authentication information on the device 101 to access this service. Also, the user can enter addressing or authentication information from a more input friendly device, such as a personal computer, rather than into the device 101 to associate it with the user's existing account 111 with the service.

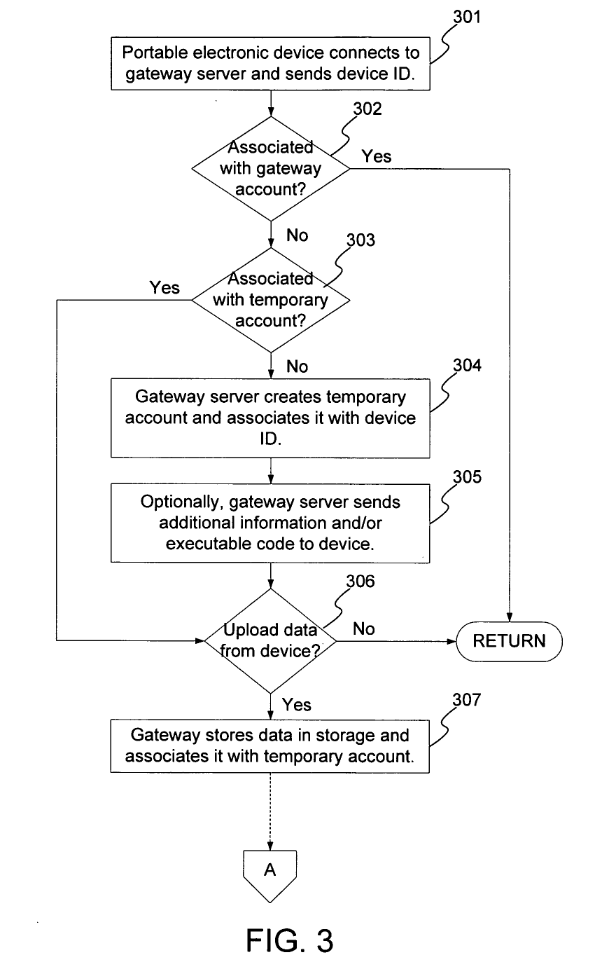

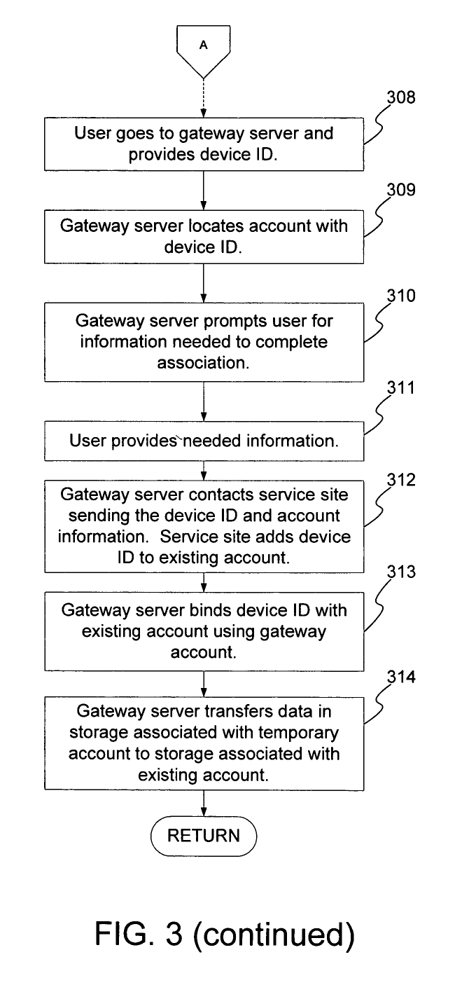

FIG. 3 is a flowchart illustrating in more detail the method for associating a portable electronic device with an existing service account with minimal user input on the device in accordance with the present invention. First, the portable electronic device 101 connects to the gateway server 105 and sends its device ID 102, via step 301. The gateway server 105 then determines if the device ID 102 is associated with a gateway account, via step 302. If not, then the gateway server 105 determines if the device ID 102 is associated with a temporary account 106, via step 303. If not, such as when the device 101 is connecting to the gateway server 105 for the first time, then the gateway server 105 creates a temporary account 106 and associates it with the device ID 102, via step 304. The gateway server 105 then optionally sends to the device 101 additional information and/or executable code, via step 305. For example, a new user ID and password, software updates, additional security or encryption information, etc. can be sent.

If data is to be uploaded from the device 101, via step 306, then the gateway server 105 stores the data in storage 107 associated with the device's temporary account 106, via step 307.

At some time later, the user visits the gateway server 115 and provides the device ID 102. The gateway server 105 locates the account identified by the device ID 102, via step 309. The gateway server 105 may prompt the user for any information needed to complete the association, via step 310, such as username and password for the existing account 111. The user then provides the needed information, via step 311. The gateway server 105 contacts the service site 110, passes it the device ID 102 and the information identifying the existing account 111 which the service site uses to locate the existing account 111 to which it adds the device ID 102. via step 312. The gateway server 105 adds the device ID 102 and existing account 111 information to the user's gateway account 108. As state previously, the user's gateway account 108 is created from the temporary account 106 if the user does not have a gateway account 108, or the information is added to the user's gateway account 108, if it is already present. The gateway server 105 transfers any data stored in storage for the temporary account 106 to the storage 112 associated with the existing account 111, via step 314.

Later, when the device 101 connects to the gateway server 105, the gateway server 105 can determine the gateway account 108 to which the device ID 102 is associated, and connect to the service site 110 with the existing account information on behalf of the device 101.

In this manner, the device 101 only needs to be configured to interoperate with the gateway server 105, shielding it from the details of interoperation with the associated service site 110. The device 101 can be setup to interoperate with any service without requiring the user to input account information via the device 101.

Alternatively, authentication and address information for the existing account 111 can be stored at the device 101, and the gateway server 105 functions as a pass through server. As another alternative, the device 101 can connect with the service site 110 directly and independently of the gateway server 105.

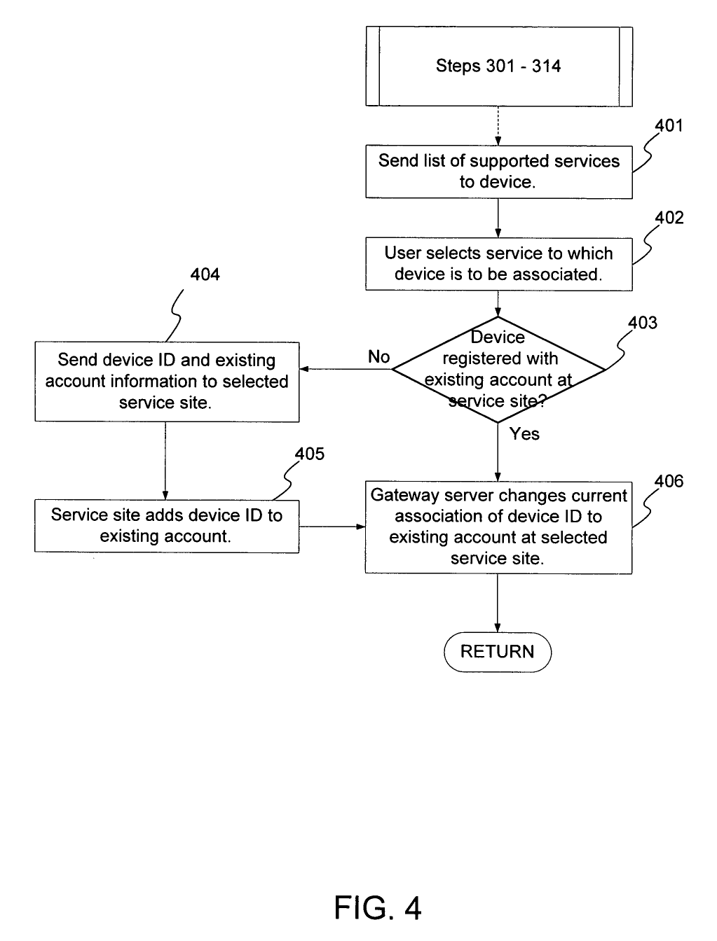

Note that this embodiment provides the ability to associate a device with more than one service. With this capability an extension to the embodiment enables the user to choose the desired service to be associated with the device 101 in real-time from the device 101. FIG. 4 is a flowchart illustrating the extension. First, steps 301 through 314 (FIG. 3) are performed as described above. At some time, the gateway server 105 sends a list of supported services to the device 101, via step 401. For example, the list can be sent each time the device 101 connects to the gateway server 105, or the user can request the list from the gateway server 105 via the device 101. This list is displayed on the device 101 to the user. The user then selects a service to which the device 101 is to be associated, via step 402. The election is communicated to the gateway server 105. The gateway server 105 communicates the device ID 102 and the existing account information to the selected service site 110, if the device has not been registered previously, via step 404. Then, the gateway server 105 and the service site 110 both associate the device ID 102 to the existing account 111 at the selected service site 110, via steps 405-406. Information in the user's gateway account is provided as needed to the service site 110. For example, the default userid and password is used to identify the user's existing account 111 by default. If this fails, the gateway server 105 requests that the device 101 prompt the user for this information (not shown). If the device 101 has already registered with the user's existing account 111, then instead of steps 405 and 406, the gateway server 105 simply changes the default association for the device in the gateway account 108, via step 406.

The user may pre-configure as many associations as desired via the gateway's web interface. This improves the performance of switching associations from the device.

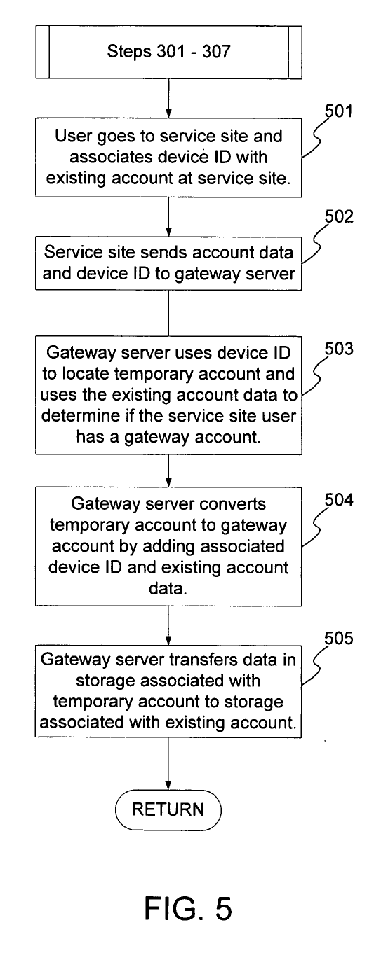

In a second embodiment, the setup may be initiated at the user's existing account 111 on the service site 110 to which the device 101 is to be associated. FIG. 5 is a flowchart illustrating the second embodiment of a method for associating a portable electronic device with an existing service account with minimal user input on the device in accordance with the present invention. First, steps 301 through 307 (FIG. 3) are performed as described above. Then, the user goes to the service site 110 directly, via an input friendly device, and associates the device ID 102 with an existing account 111 at the service site 110, via step 501. The service site 110 can provide an interface which allows the user to specify one or more device ID's. The device ID's specify which devices are to be associated with the account when accessing the service. The service site 110 sends the device ID 102 and existing account 111 data to the gateway 105, via step 502. The gateway server 105 then uses the device ID 102 to locate the temporary account 106 created for the device 101, and attempts to locate a gateway account using the existing account 111 data, via step 503. If the service site user does not have a gateway account, then the temporary account 106 is converted to a gateway account by combining the device ID 102, existing account 111 data, and the temporary account 106 data, via step 504. If a gateway account 108 was located, the device ID 102, existing account 111 data, and temporary account 106 data are added to the gateway account 108. Then, the gateway server 105 transfers data in storage 107 associated with the temporary account 106 to the storage 112 associated with the existing account 111, using the storage 109 as needed for caching, via step 505. Note that as with the previous embodiment, that the gateway server 105 and service site 110 may be deployed as one integrated site. In this case the gateway account 108 and the existing account 111 as described here may be the same account with the terms “temporary”, “gateway”, and “existing” being descriptive of the roles the accounts may take in the system. Similar statements can be made concerning the other components in the system.

A method and system for associating a portable electronic device with an existing service account with minimal user input on the device have been disclosed. The method and system connects a portable electronic device to a gateway server. If the device is not associated with an existing or a temporary account, then the gateway server creates a temporary account for the device. The gateway server then receives data from the device and stores the data for the temporary account. When the gateway server receives an association of the device to the existing account with the service site, it transfers the data for the temporary account to the existing account. In this manner, a portable electronic device can use certain services without first requiring the user to associate the device to an existing account with the service. The user need not enter addressing or authentication information on the device to access this service. Also, the user can enter addressing or authentication information from a more input friendly device, such as a personal computer, rather than into the device to associate it with the user's existing account with the service.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for associating a portable electronic device with an existing account with a service site, comprising;
(a) connecting a portable electronic device to a gateway server;
(b) creating a temporary account for the portable electronic device by the gateway server;
(c) receiving an association of the portable electronic device to the existing account with the service site by the gateway server; and
(d) converting the temporary account to a gateway account associated with the portable electronic device and the existing account.

2. The method of claim 1, wherein the receiving step (c) comprises:
(c1) receiving data from the portable electronic device by the gateway server;
(c2) storing the data for the temporary account;
(c3) receiving the association of the portable electronic device to the existing account with the service site by the gateway server; and
(c4) transferring the data for the temporary account to the existing account.

3. The method of claim 1, wherein the connecting step (a) comprises:
(a1) connecting the portable electronic device to the gateway server; and
(a2) sending a unique device identifier for the portable electronic device to the gateway server.

4. The method of claim 1, wherein the creating step (b) comprises:
(b1) determining if the portable electronic device is associated with any gateway account;
(b2) determining if the portable electronic device is associated with any temporary account, if the portable electronic device is not associated with any gateway account;
(b3) creating the temporary account for the electronic device by the gateway server, if the portable electronic device is not associated with the temporary account; and
(b4) associating the temporary account with a unique device identifier for the portable electronic device;

5. The method of claim 4, wherein the creating step (b) further comprises:
(b5) sending additional information or executable code to the portable electronic device.

6. The method of claim 4, wherein the creating step (b) further comprises:
(b5) sending a list of supported services to the portable electronic device;
(b6) receiving a selection of a supported service;
(b7) determining if the portable electronic device is registered with an existing account of the supported service;
(b8) sending the unique device identifier to the supported service and adding the unique device identifier to the existing account of the supported service, if the portable electronic device is not registered with the existing account of the supported service; and
(b9) associating the unique device identifier to the existing account of the supported service by the gateway server.

7. The method of claim 1, wherein the converting step (d) comprises:
(d1) receiving the association of the portable electronic device with the existing account with the service site from a user;
(d2) sending the association and a unique device identifier for the portable electronic device to the gateway server; and
(d3) associating the unique device identifier to the gateway account by the gateway server.

8. The method of claim 7, wherein the associating step (d3) comprises:
(d3i) prompting for any information needed to complete the association by the gateway server;
(d3ii) receiving the needed information by the gateway server; and
(d3iii) associating the unique device identifier with the gateway account by the gateway server.

9. The method of claim 2, wherein the transferring step (c4) comprises:
(c4i) identifying the temporary account associated with a unique device identifier of the portable electronic device; and
(c4ii) transferring the data in a storage associated with the temporary account to a storage associated with the existing account.

10. The method of claim 2, further comprising:
(c5) sending authentication information to the portable electronic device, wherein the portable electronic device connects to the service site directly.

11. The method of claim 1, wherein the converting step (d) comprises:
(d1) associating at the service site a unique device identifier for the portable electronic device with the existing account;
(d2) sending the unique device identifier and information for the existing account to the gateway server;
(d3) locating the temporary account by the gateway server utilizing the unique device identifier;
(d4) determining if a service site user has a gateway account; and
(d5) converting the temporary account to the gateway account by adding the unique device identifier and the information for the existing account.

12. The method of claim 11, wherein the converting step (d) further comprises:
(d6) transferring the date in a storage associated with the temporary account to a storage associated with the existing account.

13. A computer readable medium with program instructions for associating a portable electronic device with an existing account with a service site, comprising the instructions for;
(a) connecting a portable electronic device to a gateway server;
(b) creating a temporary account for the portable electronic device by the gateway server;
(c) receiving an association of the portable electronic device to the existing account with the service site by the gateway server; and
(d) converting the temporary account to a gateway account associated with the portable electronic device and the existing account.

14. The medium of claim 13, wherein the receiving instruction (c) comprises:
(c1) receiving data from the portable electronic device by the gateway server;
(c2) storing the data for the temporary account;
(c3) receiving the association of the portable electronic device to the existing account with the service site by the gateway server; and
(c4) transferring the data for the temporary account to the existing account.

15. The medium of claim 13, wherein the connecting instruction (a) comprises:
(a1) connecting the portable electronic device to the gateway server; and
(a2) sending a unique device identifier for the portable electronic device to the gateway server.

16. The medium of claim 13, wherein the creating instruction (b) comprises:
(b1) determining if the portable electronic device is associated with any gateway account;
(b2) determining if the portable electronic device is associated with any temporary account, if the portable electronic device is not associated with any gateway account;
(b3) creating the temporary account for the electronic device by the gateway server, if the portable electronic device is not associated with the temporary account; and
(b4) associating the temporary account with a unique device identifier for the portable electronic device;

17. The medium of claim 16, wherein the creating instruction (b) further comprises:
(b5) sending additional information or executable code to the portable electronic device.

18. The medium of claim 16, wherein the creating instruction (b) further comprises:
(b5) sending a list of supported services to the portable electronic device;
(b6) receiving a selection of a supported service;
(b7) determining if the portable electronic device is registered with an existing account of the supported service;
(b8) sending the unique device identifier to the supported service and adding the unique device identifier to the existing account of the supported service, if the portable electronic device is not registered with the existing account of the supported service; and
(b9) associating the unique device identifier to the existing account of the supported service by the gateway server.

19. The medium of claim 13, wherein the converting instruction (d) comprises:
(d1) receiving the association of the portable electronic device with the existing account with the service site from a user;
(d2) sending the association and a unique device identifier for the portable electronic device to the gateway server; and
(d3) associating the unique device identifier to the gateway account by the gateway server.

20. The medium of claim 19, wherein the associating instruction (d3) comprises:
(d3i) prompting for any information needed to complete the association by the gateway server;
(d3ii) receiving the needed information by the gateway server; and
(d3iii) associating the unique device identifier with the gateway account by the gateway server.

21. The medium of claim 14, wherein the transferring instruction (c4) comprises:
(c4i) identifying the temporary account associated with a unique device identifier of the portable electronic device; and
(c4ii) transferring the data in a storage associated with the temporary account to a storage associated with the existing account.

22. The medium of claim 14, further comprising:
(c5) sending authentication information to the portable electronic device, wherein the portable electronic device connects to the service site directly.

23. The medium of claim 14, wherein the converting instruction (d) comprises:
(d1) associating at the service site a unique device identifier for the portable electronic device with the existing account;
(d2) sending the unique device identifier and information for the existing account to the gateway server;
(d3) locating the temporary account by the gateway server utilizing the unique device identifier;
(d4) determining if a service site user has a gateway account; and
(d5) converting the temporary account to the gateway account by adding the unique device identifier and the information for the existing account.

24. The medium of claim 23, wherein the converting instruction (d) further comprises:
(d6) transferring the date in a storage associated with the temporary account to a storage associated with the existing account.

25. A system, comprising:
a gateway server, comprising a temporary account, wherein when a portable electronic device connects to the gateway server, the gateway server creates the temporary account for the portable electronic device, wherein if the gateway server receives an association of the portable electronic device to an existing account with a service site, the temporary account is converted to the gateway account associated with the portable electronic device and the existing account.

26. The system of claim 25, wherein if the gateway server receives data from the portable electronic device before receiving the association, the gateway server stores the data for the temporary account,
wherein when the gateway server receives the association, the gateway server transfers the data for the temporary account to the existing account.
